(19) United States
(12) Patent Application Publication
(10) Pub. No.: US 2024/0311706 A1
(43) Pub. Date: Sep. 19, 2024

(54) SYSTEM AND METHOD FOR ITINERARY PLANNING AND MANAGEMENT

(71) Applicants: Richard Thomas SLATER, Healdsburg, CA (US); Maria Yolanda SLATER, Healdsburg, CA (US)

(72) Inventors: Richard Thomas SLATER, Healdsburg, CA (US); Maria Yolanda SLATER, Healdsburg, CA (US)

(21) Appl. No.: 18/603,268

(22) Filed: Mar. 13, 2024

Related U.S. Application Data
(60) Provisional application No. 63/452,174, filed on Mar. 15, 2023.

(51) Int. Cl. G06Q 10/02

(52) U.S. Cl. CPC G06Q 10/025

(57) ABSTRACT

An itinerary planning system includes a memory and a processor. The processor executes programmed instructions for receiving a user query and personal data, generating a travel itinerary plan based on the query and personal data, identifying possible points of failure in the plan, and generating an updated plan. The system also generates a travel itinerary and an AI package that provides access to the itinerary and suggests alternate nodes and/or edges based on real-time user inputs. The system and method also involve capturing real-time and/or historical data, and implementing machine learning and other AI algorithms to rank alternate nodes and edges.

### CROSS-REFERENCE TO RELATED APPLICATIONS AND PRIORITY

The present application claims priority from U.S. Provisional Application No. “63/452174” filed on Mar. 15, 2023, entitled “Smart Travel Planner with Integrated AI and Navigation.”

### TECHNICAL FIELD

The invention relates to the domain of travel itinerary planning. More specifically, the invention relates to travel itinerary planning and management in offline mode.

### BACKGROUND

Traveling, whether for business or leisure, often requires careful planning and coordination. This is especially true when the journey involves multiple destinations, modes of transportation, and accommodations. Traditionally, travelers would have to manually research and plan their itinerary, which can be time-consuming and stressful. With the advent of the internet, numerous online tools have been developed to assist in this process. These tools gather information from various online sources such as flight booking, hotel booking, and transportation booking websites to generate a travel itinerary based on the user's inputs. However, these tools often rely on internet connectivity to function and update the itinerary. This can be problematic when the traveler is in a location with poor or no internet connectivity, or when unexpected situations such as road closures or adverse weather conditions occur, requiring a recalibration of the travel itinerary. In such situations, the traveler is left with limited options to assist them in real-time.

Thus, there is a long-felt need for a system and method of offline travel itinerary planning and management.

### SUMMARY

This summary is provided to introduce concepts related to a system and a method for offline itinerary planning and management, and the concepts are further described below in the detailed description. This summary is not intended to identify essential features of the claimed subject matter nor is it intended for use in determining or limiting the scope of the claimed subject matter.

In accordance with embodiments, an itinerary planning system is provided. The system comprises a memory and a processor configured to execute programmed instructions stored in the memory. The system receives a query from a user device, which corresponds to an itinerary, and personal data associated with the user. The system then generates a travel itinerary plan based on the query and the personal data. The travel itinerary plan is a directed graph comprising a set of preferred nodes and a set of preferred edges. The system also identifies a set of possible points of failure in the travel itinerary plan based on real-time data and/or historical data. An updated travel itinerary plan is generated based on the set of possible points of failure. The system then generates a travel itinerary and an AI package, which when deployed on a user device, renders a graphical user interface to access the travel itinerary and suggest alternate nodes and/or alternative edges based on real-time inputs received from the user.

In accordance with other embodiments, a method for itinerary planning is provided. The method involves receiving a query from a user device, which corresponds to an itinerary, and personal data associated with the user. The method then involves generating a travel itinerary plan based on the query and the personal data. The travel itinerary plan is a directed graph comprising a set of preferred nodes and a set of preferred edges. The method also involves identifying a set of possible points of failure in the travel itinerary plan based on real-time data and/or historical data. An updated travel itinerary plan is generated based on the set of possible points of failure. The method then involves generating a travel itinerary and an AI package, which when deployed on a user device, renders a graphical user interface to access the travel itinerary and suggest alternate nodes and/or alternative edges based on real-time inputs received from the user.

### BRIEF DESCRIPTION OF DRAWINGS

The detailed description is described with reference to the accompanying Figures. The same numbers are used throughout the drawings to refer like features and components.

FIG. 1 illustrates a network implementation 100 of an Itinerary planning system, in accordance with an embodiment of the present disclosure.

FIG. 2 illustrates a block diagram of the Itinerary planning system, in accordance with an embodiment of the present disclosure.

FIG. 3 illustrates a flowchart 300 for generating a travel itinerary, in accordance with an embodiment of the present disclosure.

FIG. 4 illustrates a directed graph representing a final travel itinerary, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

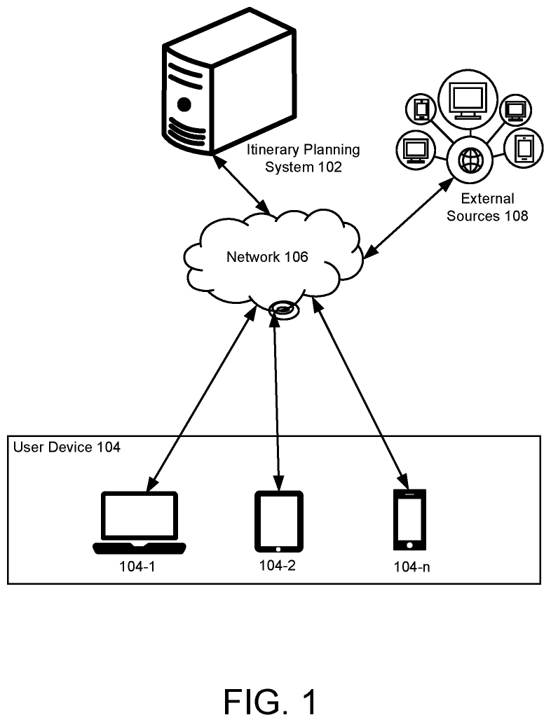

Referring to FIG. 1, network implementation 100 of an Itinerary Planning System 102 for generating a travel itinerary is illustrated, in accordance with an embodiment of the present subject matter. In one embodiment, the Itinerary Planning System 102 (hereinafter referred as the system 102) may comprise a processor and a memory. Further, the system 102 may be connected to user devices 104 or applications residing over the user devices 104 through a network 106. It may be understood that the system 102 may be communicatively coupled with the user through one or more user devices/applications 104-1, 104-2, . . . , 104-n collectively referred to as a user device 104.

In one embodiment, the network 106 may be a cellular communication network used by user devices 104 such as mobile phones, tablets, or a virtual device. In one embodiment, the cellular communication network may be the Internet. The user device 104 may be any electronic device, communication device, image capturing device, machine, software, automated computer program, a robot or a combination thereof. The system 102 may be configured to register users over the system 102. Further, the system 102 may be configured to authenticate the user, each time the user makes a request to access the system 102.

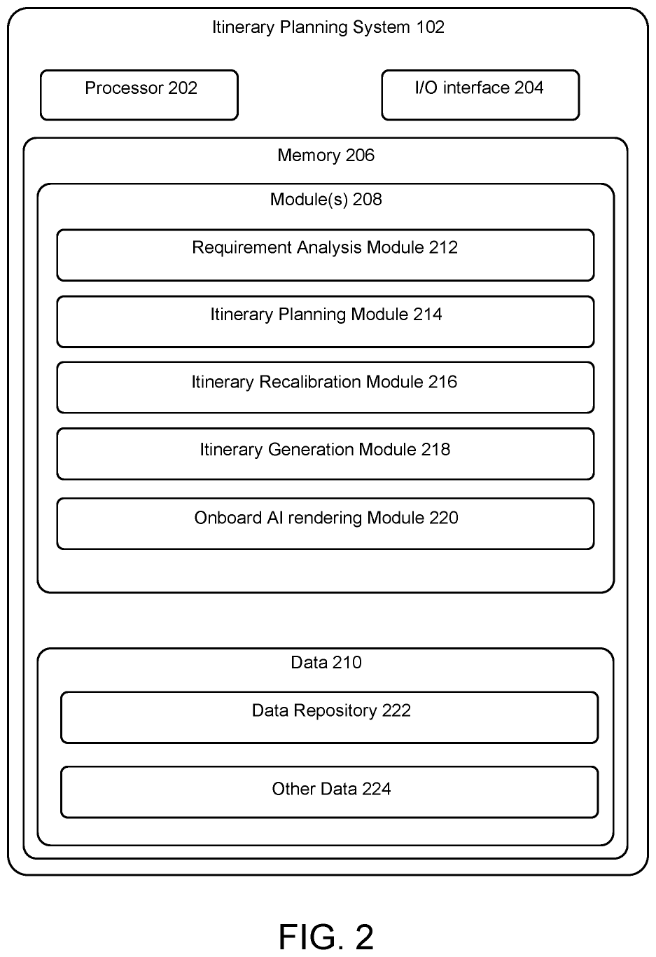

In one embodiment, the user devices 104 may support communication over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. The aforementioned user devices 104 and network 106 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. The block diagram 200 of the of the Itinerary planning system 102 is further illustrated in FIG. 2.

Referring now to FIG. 2, various components of the system 102 are illustrated, in accordance with an embodiment of the present subject matter. As shown, the system 102 may include at least one processor 202, an I/O interface 204 and a memory 206. The memory consists of programmed instructions corresponding to a set of modules 208 and data 210. The set of modules 208 may include a Requirement Analysis Module 212, an Itinerary Planning Module 214, an Itinerary Recalibration Module 216, an Itinerary Generation Module 218, and an Onboard AI rendering Module 220. In one embodiment, the at least one processor 202 is configured to fetch and execute computer-readable instructions, stored in the memory 204, corresponding to each module 208. It must be noted that though the invention is explained considering that the system 102 is deployed over a remote server and the user device 104 is communicatively coupled with the system 102 through the network 106. However, it must be noted that the system 102 or modules 208 of the system 102 may also be deployed on the user device 104 itself and the modules 208 perform the same functions as that on the server using the local hardware of the user device 104. By implementing the system 102 on the user device 104, the data privacy of user's personal data is maintained as the data never leaves the user device 104.

In one embodiment, the memory 204 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The data 210 may comprise a data repository 222, and other data 224. The other data 224 amongst other things, serves as a repository for storing data processed, received, and generated by one or more components and programmed instructions. The working of the system 102 will now be described in detail referring to FIG. 2.

In one embodiment, the Requirement Analysis Module 212 is configured for receiving a query from a user device 104 of a user. The query may correspond to inputs received from a user for planning an itinerary for traveling to a remote location, business trips, planning new activities or events. The query may comprise data corresponding to basic information, associated with the itinerary, including source, destination, date, time, and other information associated with the itinerary. Further, the Requirement Analysis Module 212 is configured for receiving personal data associated with the user. The personal data may be captured from user device as well as online sources such as social media websites. The personal data comprises at least user preferences and users historical travel data.

Further, the Itinerary Planning Module 214 aggregates data from one or more external sources 108 for generating a travel itinerary plan based on the query and the personal data gathered by the Requirement Analysis Module 212. The one or more external sources 108 include ticket booking, hotel booking, transportation booking website and applications. It must be noted that the travel itinerary plan is a directed graph. The directed graph comprises a set of preferred nodes and a set of preferred edges connecting the set of preferred nodes. Each preferred node corresponds to an intermediate destination in the travel itinerary plan. The intermediate destination may correspond to at least one of hotels, lodges, places, and destination points in the travel itinerary plan. Further, each preferred edge from the set of preferred edges corresponds to a transportation option between two adjacent preferred nodes in the set of preferred nodes in the travel itinerary plan. The transportation option includes flight, boat, train, car, cab, car-pooling and all other travel options between two adjacent preferred nodes in the travel itinerary plan. The preferred nodes and preferred edges are selected based on the personal data and query received from the user device 104.

Further, the Itinerary Recalibration Module 216 analyses the travel itinerary plan and identifies a set of possible points of failure in the travel itinerary plan. The set of possible points of failure correspond to one or more preferred edges or one or more preferred nodes from the set of preferred nodes and set of preferred edges. The set of possible points of failure are identified based on real-time data and/or historical data associated with the set of preferred nodes and/or the set of preferred edges.

Further, the Itinerary Recalibration Module 216 is configured for generating an updated travel itinerary plan based on the set of possible points of failure. The updated travel itinerary plan may comprise a set of alternate nodes and a set of alternate edges along with the set of preferred nodes and the set of preferred edges. The Itinerary Recalibration Module 216 is server-side Artificial Intelligence engine. The process of suggesting alternate nodes and alternative edges by the Itinerary Recalibration Module 216 is based on the user preferences and users historical travel data. It must also be noted that the Itinerary Recalibration Module 216, may also consider ‘wildcard’ options (activities or destinations outside the user preferences and users historical travel data) in the process of suggesting alternate nodes and alternate edges to cover the possibility of wildcard or impulse user inputs. Furthermore, the Itinerary Recalibration Module 216 is configured to implement machine learning and other Artificial Intelligence algorithms to rank the alternate nodes and alternative edges and suggested to the user with at least one alternate node and/or alternative edge based on the real-time inputs received from the user during his journey as per the updated travel itinerary plan. In order to rank the alternate nodes and alternate edges, a combination of a probability of occurrence of unexpected situations as well as user preferences and users historical travel data may be used.

Further, the Itinerary Generation Module 218 is configured for consuming the travel itinerary plan and updated travel itinerary plan to generate a final travel itinerary.

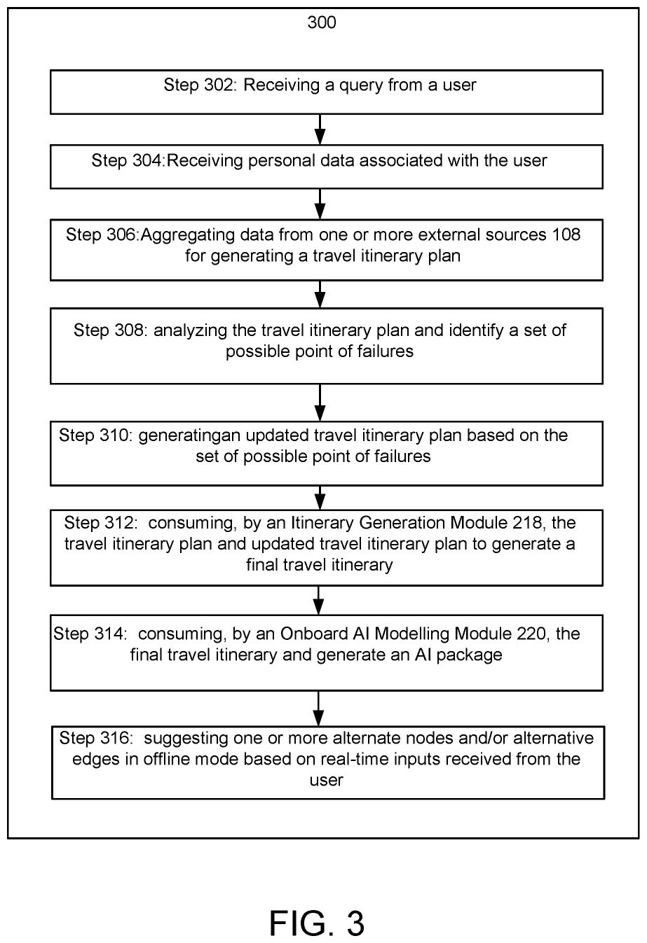

Further, the Onboard AI Modelling Module 220 consumes the final travel itinerary and generates an AI package to assist the user in a journey based on the final travel itinerary. Furthermore, the AI package, when deployed on the user device 104, renders a graphical user interface over the user device 104 to access the final travel itinerary and suggest one or more alternate nodes and/or alternative edges in offline mode based on real-time inputs received from the user. The real-time inputs are received from the user during a journey as per the final travel itinerary. The detailed working of the system 102 for generating the personalized final travel itinerary is illustrated with the flowchart of FIG. 3.

Referring now to FIG. 3 illustrates a flowchart 300 for generating a personalized travel itinerary, in accordance with an embodiment of the present disclosure.

At step 302 the Itinerary Planning System 102 receiving a query from a user's device. This query is a set of data points that specify the user's travel requirements, including the starting point, destination, dates, and times for the planned trip. The user inputs this information into their user device 104, which is then received with the Requirement Analysis Module 212 within the system 102. The data in the query encompasses the foundational aspects of the itinerary, such as source, destination, date, time, and other relevant travel details. The user device 104 serves as the conduit for this data input, and the Requirement Analysis Module 212 is configured for collecting and processing the data.

At step 304, the personal data associated with the user is received by the Requirement Analysis Module 212. The personal data provides necessary parameters to construct a travel itinerary that aligns with the user's schedule and preferences. More specifically, the personal data includes user preferences and historical travel data, which are essential for the system 102 to tailor the travel itinerary to the individual's specific needs and past behaviors. In one embodiment, the Requirement Analysis Module 212 may capture this data from the user device 104 as well as from online sources. The user device 104 may include smartphones, tablets, laptops, or any other device capable of interfacing with the system 102. Online sources could be databases, social media platforms, travel websites, or any digital repository that stores user-related information. The user device 104 provides personal data, such as current preferences of the user. The Online sources contribute additional layers of data, such as historical travel patterns, past bookings, and user reviews, which may be stored in cloud services or other data storage systems. The Requirement Analysis Module 212 of the System 102 aggregates this data to understand the user's travel habits, preferred destinations, favored modes of transportation, budget constraints, and other relevant factors that influence travel decisions. The purpose of collecting the personal data is to enable the system 102 to create a travel itinerary that aligns with the user's preferences and historical behavior. This data-driven approach ensures that the system 102 can make informed decisions when selecting nodes (intermediate destinations like hotels or destination points) and edges (transportation options such as flights or car rentals) during the itinerary planning process.

In other words, the set of data points and personal data is processed by the Requirement Analysis Module 212 to identify patterns and preferences, which would be used in subsequent steps to generate a travel itinerary that is customized to the user's profile. In practice, at step 302 and 304 the user enters their trip details, which the Requirement Analysis Module 212 processes. This involves parsing the data, ensuring its validity, and storing it for subsequent use in the itinerary planning process. This step sets the parameters for the travel plan and influences the system's subsequent actions in tailoring the itinerary to meet the user's specified needs.

At step 306, the process of extracting data from various online platforms, which include ticket booking, hotel booking, and transportation booking websites and applications is performed by the Itinerary Planning Module 214. This process is executed by the Itinerary Planning Module 214 to collect information relevant to a user's travel itinerary. The data gathered includes details about potential stops and transportation options between these stops.

Further, at step 306, the Itinerary Planning Module 214 generates a travel itinerary plan. The travel itinerary plan is a directed graph, consisting of nodes and edges. Each node represents a stop that the user may visit or stay at during their trip. The edges represent the transportation options available to travel between these nodes. The Itinerary Planning Module 214 selects these nodes and edges based on data that includes the user's preferences and historical travel data. This ensures that the travel itinerary plan is personalized to the user's specific needs and past behaviors. The process of extracting data is governed by algorithms that determine which data to extract and how to interpret it to construct the directed graph. This involves parsing the data, identifying relevant information, and organizing it into a structured format that can be used to create the travel itinerary plan. It must be understood that the Itinerary Planning Module 214 handles variations in data formats and ensures the accuracy of the information being collected.

More specifically, at step 306, the Itinerary Planning Module 214 generates a comprehensive travel itinerary plan that serves as a foundation for further analysis, such as identifying potential points of failure and generating updated plans with alternate nodes and edges.

At step 308, the Itinerary Planning Module 214 conducts an analysis of the travel itinerary plan to pinpoint potential points of failure. This step is essential for enhancing the reliability of the itinerary by anticipating issues that could disrupt the travel. The Itinerary Planning Module 214 scrutinizes the travel itinerary plan to identify a set of possible points of failure. As stated earlier, the travel itinerary plan is a directed graph composed of preferred nodes and edges representing intermediate destinations and transportation options, respectively.

Further, the Itinerary Planning Module 214 performs several functions to examine historical data and real-time data from various internet sources, such as ticket booking, hotel booking, and transportation booking websites and applications. The purpose of this analysis is to identify any potential disruptions that could occur during the user's journey. These disruptions could be related to any of the preferred edges or nodes, such as flight cancellations, hotel overbookings, or road closures.

The historical data used in this analysis could include patterns of delays or cancellations for flights, seasonal weather conditions affecting travel, or recurring traffic issues in certain areas. Real-time data might consist of current weather forecasts, live traffic updates, or last-minute changes in accommodation availability. By analyzing this data, the Itinerary Planning Module 214 may predict and identify possible future disruptions in the travel itinerary plan.

In one embodiment, the identification of possible points of failure is based on the historical reliability of each node and edge in the itinerary. For instance, if a particular flight route is known to have frequent delays, this would be flagged as a potential point of failure. Similarly, if a hotel is undergoing renovations and may not have all rooms available, this too would be identified as a possible issue.

The Itinerary Planning Module 214 uses machine learning and artificial intelligence algorithms to process and analyze this historical data and real-time data. These algorithms can learn from past data to predict future issues and rank the potential points of failure based on their likelihood and potential impact on the user's itinerary.

In summary, step 308 the Itinerary Planning Module 214 uses AI and machine learning to analyze historical and real-time data from various sources to identify and predict potential disruptions in the travel itinerary and generate the set of possible points of failure. This proactive approach aims to enhance the user's travel experience by minimizing the risk of unforeseen problems. Also, it must be noted that the user preferences may change during the travel and the user may look for other options that are outside the scope of the preferred nodes and preferred edges. Thus, while calibrating the set of possible points of failure, the Itinerary Planning Module 214 may also take into consideration such situations where the user himself might want to change his preferred choices on the fly and prefer visiting a different destination or taking a different transportation means than what is specified in the travel itinerary plan.

Furthermore, at step 310 an updated travel itinerary plan that takes into account potential points of failure identified in the original travel itinerary plan is generated. This step is essential for providing a user with a travel plan that can adapt to unexpected changes.

The actions involved in step 310 are as follows:
1. **Analyzing Possible Points of Failure**: The Itinerary Recalibration Module 216 examines the travel itinerary plan to pinpoint potential disruptions. These disruptions could be specific preferred edges or nodes, such as transportation options or intermediate destinations that have a higher likelihood of causing delays or cancellations in the itinerary. The identification is based on data and historical data associated with the preferred nodes and edges, which could include factors like historical delays, cancellations, weather conditions, or other relevant travel disruptions.
2. **Generating Updated Itinerary Plan**: After identifying the possible points of failure, the Itinerary Recalibration Module 216 creates an updated travel itinerary plan. This updated travel itinerary plan includes a set of alternate nodes and alternate edges alongside the original set of preferred nodes and preferred edges. The inclusion of alternate nodes and edges provides the user with additional options to reach their destination, thereby reducing the risk associated with the future disruptions.
3. **Incorporating User Preferences and Historical Data**: The process of generating the updated travel itinerary plan takes into account the user's preferences and historical travel data. This ensures that the alternate nodes and edges are not only viable but also consistent with the user's travel habits and preferences. The alternate nodes and edges may be ranked based on the user's travel habits and preferences. This ranking may be used for suggesting alternate travel options and destinations to the user in case of roadblocks faced during his journey.
4. **Utilizing Machine Learning and AI Algorithms**: The Itinerary Recalibration Module 216 uses machine learning and AI algorithms to evaluate the alternate nodes and edges. These algorithms consider various factors such as the likelihood of success, user satisfaction, cost, time, and other relevant metrics to suggest the most suitable options to the user.
5. **Preparing for Real-Time Recalibration**: The updated travel itinerary plan is designed to respond to inputs received from the user during their travel. This means that if a disruption occurs while the user is traveling, the system can quickly adjust the itinerary to suggest the best routes or destinations on the fly without any connectivity to the internet.

In one embodiment, the Itinerary Recalibration Module 216 operates as a server-side AI engine that utilizes machine learning and other AI algorithms to process the user's travel-related information. User preferences might include factors such as travel times, modes of transportation, budget, and desired amenities, while historical travel data provides insight into past travel behaviors. Further, The Itinerary Recalibration Module 216 ranks alternate nodes and alternative edges by evaluating parameters such as cost, travel time, convenience, and user ratings. This ranking is based on a mathematical construct that assigns weights to these parameters in accordance with the user's provided information and past data. The system generates a set of ranked alternatives that can be suggested to the user in case of disruptions in the original travel itinerary plan. Further, the Itinerary Recalibration Module 216 employs machine learning algorithms, which could include decision trees, neural networks, or reinforcement learning, to analyze the data and generate suggestions. These algorithms consider inputs received from the user during travel, such as delays, changes in plans, or medical emergency. The system then dynamically suggests at least one alternate node (e.g., a different hotel) and/or alternative edge (e.g., a different flight route) that aligns with the user's updated situation and preferences. The Itinerary Recalibration Module 216 operates in conjunction with other modules, including the Requirement Analysis Module 212 and the Onboard AI Modelling Module 218. These modules collectively ensure that the user's travel itinerary is adaptable to changes and disruptions, providing a seamless travel experience even when offline. The Itinerary Recalibration Module 216 uses AI algorithms to analyze user data and inputs to suggest personalized travel options that are resilient to unexpected events, ensuring that the user's travel itinerary remains practical and flexible. In summary, step 310 involves the use of AI and machine learning to analyze travel data, pinpoint potential disruptions, and generate an alternate travel plan that is personalized to the user's preferences and historical travel patterns. This step ensures that the user is provided with a resilient travel itinerary that can adapt to changes and disruptions, enhancing the overall travel experience.

The Itinerary Generation Module 218 processes the initial travel itinerary plan and the updated travel itinerary plan to produce a final travel itinerary. This step synthesizes information from the preferred nodes and edges, which represent the user's initial travel preferences, with the alternate nodes and edges that provide backup options in case of identified possible points of failure. These points of failure are determined by analyzing historical and real-time data related to the preferred nodes and edges, as outlined in steps 308 and 310. The Itinerary Generation Module 218 functions as an aggregator, integrating data from one or more sources to create a comprehensive travel plan.

The final travel itinerary produced by step 312 is a result of complex data processing, which includes the selection and ranking of nodes and edges based on various criteria such as user preferences, historical data, and the likelihood of disruptions.

The Itinerary Generation Module 218 compiles all the gathered and analyzed data to produce the final travel itinerary that is personalized and equipped to adapt to unforeseen circumstances. This step is essential for delivering a travel plan that the user can rely on, even when internet connectivity is not available. However, this final travel itinerary is still resident on the system 102. In order to make the travel itinerary work on the user device 104 in an offline mode the AI package is generated in subsequent steps, specifically step 314.

The Step 314 involves the Onboard AI Modelling Module 220 for processing the travel itinerary data to create an AI package. This package is designed to be deployed on a user device 104, enabling the user to interact with their travel itinerary without an active internet connection. The process of “consuming the travel itinerary” refers to the Onboard AI Modelling Module 220 taking the final travel itinerary data, which includes preferred nodes and edges, as well as alternate nodes and edges, as input.

The creation of the AI package involves compiling algorithms, data structures, and user interface components into a software package that can operate independently of internet connectivity. This package provides a graphical user interface on the user device, allowing the user to access their travel itinerary and receive suggestions for alternates based on inputs provided during travel.

The package is equipped with pre-loaded data and algorithms that can suggest the best possible travel options in response to changes such as delays or cancellations. These suggestions are generated using machine learning and artificial intelligence algorithms that have been trained on historical travel data and user preferences. The package is optimized to ensure compatibility with a range of user devices with varying hardware capabilities.

In essence, Step 314 describes the process of creating a tool that enables users to manage their itineraries and receive suggestions for travel options in situations where internet access is unavailable, by using pre-loaded data and intelligent algorithms.

Further, at step 316 a graphical user interface (GUI) is rendered on a user device 104 to provide access to a travel itinerary and to offer suggestions for alternate nodes and/or edges based on inputs received from the user while in offline mode or online mode during the journey of the user. The GUI serves as the interactive platform through which the user can view their current travel plans and assess the proposed adjustments. The design of the GUI focuses on facilitating user interaction with the system, allowing for the review and modification of travel plans.

The AI package when deployed on the user device encompasses the system's capability to accept inputs from the user during their journey. These inputs may include manual updates such as changes to destinations or timings, or they may be sensor-derived data from the user's device, such as location or speed. Utilizing these inputs, the system recalibrates the itinerary by offering alternate nodes, which may include different accommodations or points of interest, and alternative edges, which may represent various modes of transportation that are available and practical for the user's current circumstances.

The offline mode is made possible by the AI package that has been pre-loaded onto the user's device. This package contains algorithms that process the user's inputs on the fly along with the itinerary data to generate new travel options. These algorithms have been developed to process information regarding user preferences and historical travel data, as well as to assess the viability of different travel routes and accommodations.

In essence, at step 316 the interaction between the user, the AI package, and the GUI is rendered. The user provides inputs, the AI package once deployed over the user device 104 processes these inputs along with the stored itinerary data, and the GUI displays the recalibrated travel options for the user's consideration. This interaction enables travelers to adjust their plans in response to changes encountered during their journey, even without internet connectivity, thereby enhancing the flexibility and adaptability of their travel experience.

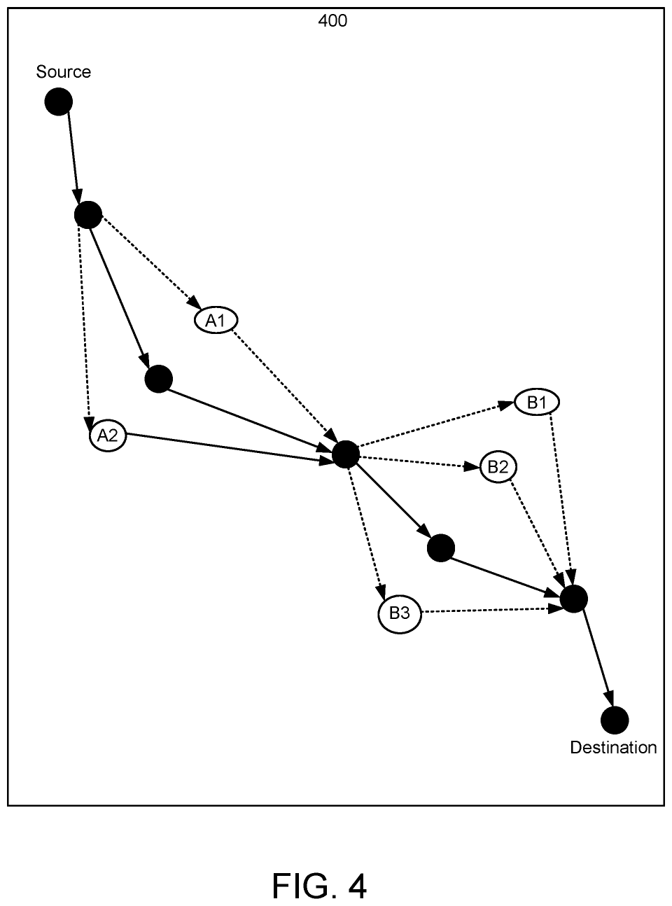

Referring now to FIG. 4, a directed graph 400 representing a final travel itinerary for visiting a set of wineries in a particular location is illustrated. The directed graph 400 may comprise the preferred set of nodes (represented in black color) and the preferred set of edges (represented in solid arow) as discussed earlies. Furthermore, the directed graph 400 may comprise set of alternate nodes (A1, A2, B1, B2, B3 . . . ) and the Alternate set of edges (represented in dashed arow). A user may visualise the directed graph 400 on the GUI of the user device 104 and provide inputs in real-time with respect to the current problems faced by the user. Based on the text/audio inputs provided by the user, the directed graph on the GUI of the user device 104 may automatically change and reorganise the nodes and edges to address the users concerns.

Although implementations for the system 102 and the method 300 for itinerary planning, have been described in language specific to structural features and methods, it must be understood that the claims are not limited to the specific features or methods described. Rather, the specific features and methods are disclosed as examples of implementations for the system 102 and the method 300 for itinerary planning.

1. An Itinerary planning system, wherein the itinerary planning system comprises:
a memory; and
a processor coupled to the memory wherein the processor is configured to execute programmed instructions stored in the memory for:
receiving, by a Requirement Analysis Module, a query from a user, wherein the query corresponds to an itinerary;
receiving, by the Requirement Analysis Module, personal data associated with the user;
aggregating, by an Itinerary Planning Module, data from one or more external sources for generating a travel itinerary plan based on the query and the personal data gathered by the Requirement Analysis Module, wherein the travel itinerary plan is a directed graph, wherein the directed graph comprises a set of preferred nodes and a set of preferred edges connecting the set of preferred nodes, wherein each preferred node corresponds to an intermediate destination in the travel itinerary plan, wherein each preferred edge from the set of preferred edges corresponds to a transportation option between two adjacent preferred nodes in the set of preferred nodes in the travel itinerary plan, wherein the preferred nodes and preferred edges are selected based on the personal data;
analysing, by an Itinerary Recalibration Module, the travel itinerary plan and identify a set of possible points of failure in the travel itinerary plan, wherein the set of possible points of failure correspond to one or more preferred edges or one or more preferred nodes from the set of preferred nodes and set of preferred edges, wherein the set of possible points of failure are identified based on real-time data and/or historical data associated with the set of preferred nodes and/or the set of preferred edges;
generating, by the Itinerary Recalibration Module, an updated travel itinerary plan based on the set of possible points of failure, wherein the updated travel itinerary plan comprises a set of alternate nodes and a set of alternate edges along with the set of preferred nodes and the set of preferred edges;
consuming, by an Itinerary Generation Module, the travel itinerary plan and updated travel itinerary plan to generate a final travel itinerary; and
consuming, by an Onboard AI Modelling Module, the final travel itinerary and generate an AI package to assist the user in a journey based on the final travel itinerary.

2. The Itinerary planning system as claimed in claim 1, wherein the AI package, when deployed on a user device, renders a graphical user interface over the user device to assist the user in a journey based on the final travel itinerary and suggest one or more alternate nodes and/or alternative edges in offline mode based on real-time inputs received from the user.

3. The Itinerary planning system as claimed in claim 1, wherein the query comprises data corresponding to basic information, associated with the itinerary, including source, destination, date, time, and other information associated with itinerary.

4. The Itinerary planning system as claimed in claim 1, wherein the personal data is captured from user device as well as online sources, wherein the personal data comprises at least user preferences and users historical travel data.

5. The Itinerary planning system as claimed in claim 1, wherein the one or more external sources 108 include ticket booking, hotel booking, transportation booking website and applications.

6. The Itinerary planning system as claimed in claim 1, wherein the intermediate destination corresponds to at least one of hotels, lodges, places, and destination points.

7. The Itinerary planning system as claimed in claim 1, wherein the transportation option includes flight, boat, train, car, cab, car-pooling and all other travel options between two adjacent preferred nodes.

8. The Itinerary planning system as claimed in claim 1, wherein the real-time data and/or the historical data is captured from the online sources and/or the user device.

9. The Itinerary planning system as claimed in claim 1, wherein the real-time inputs are received from the user during a travel as per the final travel itinerary.

10. The Itinerary planning system as claimed in claim 9, wherein the Itinerary Recalibration Module is server-side Artificial Intelligence engine, wherein the process of suggesting alternate nodes and alternative edges by the Itinerary Recalibration Module is based on the user preferences and users historical travel data, and wherein the Itinerary Recalibration Module is configured to implement machine learning and other Artificial Intelligence algorithms to rank the alternate nodes and alternative edges and suggested to the user with at least one alternate node and/or alternative edge based on the real-time inputs received from the user, wherein the Itinerary Recalibration Module is configured to rank the alternate nodes and alternate edges based on a combination of a probability of occurrence of the unexpected situations as well as user preferences and users historical travel data.

11. A method for itinerary planning, wherein the method comprises steps of:
receiving, by a Requirement Analysis Module, a query from a user, wherein the query corresponds to an itinerary;
receiving, by the Requirement Analysis Module, personal data associated with the user;
aggregating, by an Itinerary Planning Module, data from one or more external sources for generating a travel itinerary plan based on the query and the personal data gathered by the Requirement Analysis Module, wherein the travel itinerary plan is a directed graph, wherein the directed graph comprises a set of preferred nodes and a set of preferred edges connecting the set of preferred nodes, wherein each preferred node corresponds to an intermediate destination in the travel itinerary plan, wherein each preferred edge from the set of preferred edges corresponds to a transportation option between two adjacent preferred nodes in the set of preferred nodes in the travel itinerary plan, wherein the preferred nodes and preferred edges are selected based on the personal data;
analysing, by an Itinerary Recalibration Module, the travel itinerary plan and identify a set of possible points of failure in the travel itinerary plan, wherein the set of possible points of failure correspond to one or more preferred edges or one or more preferred nodes from the set of preferred nodes and set of preferred edges, wherein the set of possible points of failure are identified based on real-time data and/or historical data associated with the set of preferred nodes and/or the set of preferred edges;
generating, by the Itinerary Recalibration Module is configured to generate an updated travel itinerary plan based on the set of possible points of failure, wherein the updated travel itinerary plan comprises a set of alternate nodes and a set of alternate edges along with the set of preferred nodes and the set of preferred edges;
consuming, by an Itinerary Generation Module, the travel itinerary plan and updated travel itinerary plan to generate a final travel itinerary; and
consuming, by an Onboard AI Modelling Module, the final travel itinerary and generate an AI package to assist the user in a journey based on the final travel itinerary.

12. The method as claimed in claim 11, wherein the AI package, when deployed on a user device, renders a graphical user interface over the user device to assist the user in a journey based on the final travel itinerary and suggest one or more alternate nodes and/or alternative edges in offline mode based on real-time inputs received from the user.

13. The method as claimed in claim 11, wherein the query comprises data corresponding to basic information, associated with the itinerary, including source, destination, date, time, and other information associated with itinerary.

14. The method as claimed in claim 11, wherein the personal data is captured from user device as well as online sources, wherein the personal data comprises at least user preferences and users historical travel data.

15. The method as claimed in claim 11, wherein the one or more external sources include ticket booking, hotel booking, transportation booking website and applications.

16. The method as claimed in claim 11, wherein the intermediate destination corresponds to at least one of hotels, lodges, places, and destination points.

17. The method as claimed in claim 11, wherein the transportation option includes flight, boat, train, car, cab, car-pooling and all other travel options between two adjacent preferred nodes.

18. The method as claimed in claim 11, wherein the real-time data and/or the historical data is captured from the online sources and/or user device.

19. The method as claimed in claim 11, wherein the real-time inputs are received from the user during a travel as per the final travel itinerary.

20. The method as claimed in claim 19, wherein the Itinerary Recalibration Module is server-side Artificial Intelligence engine, wherein the process of suggesting alternate nodes and alternative edges by the Itinerary Recalibration Module is based on the user preferences and users historical travel data, and wherein the Itinerary Recalibration Module is configured to implement machine learning and other Artificial Intelligence algorithms to rank the alternate nodes and alternative edges and suggested to the user with at least one alternate node and/or alternative edge based on the real-time inputs received from the user, wherein the Itinerary Recalibration Module is configured to rank the alternate nodes and alternate edges based on a combination of a probability of occurrence of the unexpected situations as well as user preferences and users historical travel data.
